(19) United States
(12) Patent Application Publication
(10) Pub. No.: US 2026/0355834 A1
(43) Pub. Date: Nov. 12, 2026

(54) POWERED COPING SAW

(71) Applicant: Black & Decker Inc., New Britain, CT (US)

(72) Inventors: William John Bauer, Peach Bottom, PA (US); Andrew Christopher Buchko, Lutherville, MD (US); Sam Joseph Cassell, Monkton, MD (US); Logan McDonald Gallant, Lutherville-Timonium, MD (US); Madeline Ann Keffer, Sykesville, MD (US); Michael David Weiss, Phoenix, MD (US)

(21) Appl. No.: 19/668,047

(22) Filed: May 5, 2026

Related U.S. Application Data
(60) Provisional application No. 63/800,798, filed on May 6, 2025.

(51) Int. Cl. B23D 49/16; B23D 51/12

(52) U.S. Cl. CPC B23D 49/162; B23D 51/125

(57) ABSTRACT

A powered coping saw may include a housing having a handle. A powered coping saw may include a saw blade. A powered coping saw may include a frame attached to the housing. A powered coping saw may include an actuator at least partially disposed within the housing, where the actuator includes: an electric motor, a Scotch yoke mechanism driven by the electric motor and having a plurality of openings, the Scotch yoke mechanism to translate rotational motion of the electric motor to reciprocating motion of the saw blade, and a blade adjustment component to lock the saw blade in position using the plurality of openings.

### CROSS REFERENCE TO RELATED APPLICATION

This application claims priority to and the benefit of U.S. Provisional Application No. 63/800,798, filed May 6, 2025, and titled “Powered Coping Saw”, which is hereby incorporated by reference in its entirety.

### TECHNICAL FIELD

This description relates generally to a powered saw, and more particularly, to a powered saw for making precision cuts, such as a powered coping saw.

### BACKGROUND

When two pieces of trim or molding are brought together at an internal corner, the options are either to miter the ends being brought together to attempt a consistent meeting or to cope one of the ends being brought together. Coping refers to a special type of cut that runs along an edge of a material, including when one side of a joint has the profile of the overlapping section cut to provide a better matching point. This cut is used to join two pieces of material together that may have curves or complex shapes. A current method of coping may include using a hand-powered, manual coping saw. Manual hand coping can be tiring, slow, and tedious work. Other current methods of coping may include using power tools that are not intended for coping. A dedicated, powered approach would cut down on user time and provide a safer method to cope trim that does not use power tools in unintended ways.

### SUMMARY

In some aspects, the techniques described herein relate to a coping saw including: a housing having a handle; a saw blade; a frame attached to the housing; and an actuator at least partially disposed within the housing, wherein the actuator includes: an electric motor, a Scotch yoke mechanism driven by the electric motor and having a plurality of openings, the Scotch yoke mechanism to translate rotational motion of the electric motor to reciprocating motion of the saw blade, and a blade adjustment component to lock the saw blade in position using the plurality of openings.

In some aspects, the techniques described herein relate to a coping saw, wherein: the blade adjustment component is slidably removable from the housing; and the Scotch yoke mechanism is rotatable to rotate the saw blade and to lock the saw blade in a different position.

In some aspects, the techniques described herein relate to a coping saw, wherein: the Scotch yoke mechanism includes a spool having a first end having the plurality of openings and a second end having the plurality of openings.

In some aspects, the techniques described herein relate to a coping saw, wherein: the blade adjustment component includes at least one rail to interlock with one of the plurality of openings on the first end and the second end to lock the saw blade in position.

In some aspects, the techniques described herein relate to a coping saw, wherein: the blade adjustment component includes at least two rails to interlock with at least two of the plurality of openings on the first end and the second end to lock the saw blade in position.

In some aspects, the techniques described herein relate to a coping saw, further including: a tension control mechanism having a spring to maintain tension on the saw blade as the saw blade reciprocates.

In some aspects, the techniques described herein relate to a coping saw, wherein the tension control mechanism includes: a shroud at least partially enclosing the spring; and a detensioner that is disposed within the shroud and configured to move within the shroud to compress the spring and to relieve tension on the saw blade.

In some aspects, the techniques described herein relate to a coping saw including: a housing having a handle; a saw blade; a frame attached to the housing; an actuator at least partially disposed within the housing, the actuator to impart linear motion to the saw blade; and a tension control mechanism having a spring to maintain tension on the saw blade as the saw blade reciprocates wherein the tension control mechanism includes: a shroud at least partially enclosing the spring; and a detensioner that is disposed within the shroud and configured to move within the shroud to compress the spring and to relieve tension on the saw blade.

In some aspects, the techniques described herein relate to a coping saw wherein the actuator includes: an electric motor, a Scotch yoke mechanism driven by the electric motor and having a plurality of openings, the Scotch yoke mechanism to translate rotational motion of the electric motor to reciprocating motion of the saw blade, and a blade adjustment component to lock the saw blade in position using the plurality of openings.

In some aspects, the techniques described herein relate to a coping saw, wherein the shroud includes at least one opening, and wherein the detensioner includes at least one arm configured to extend outside of the shroud through the at least one opening to provide a gripping area for a user to move the detensioner.

In some aspects, the techniques described herein relate to a coping saw, wherein the detensioner is rotatable within the shroud to engage the at least one arm with a portion of the shroud and lock the detensioner in a detension state that relieves the tension on the saw blade.

In some aspects, the techniques described herein relate to a coping saw, wherein the detensioner includes a body portion having a hollow section, wherein the hollow section is sized to receive a top portion of the spring such that the top portion of the spring engages an interior surface of the hollow section.

In some aspects, the techniques described herein relate to a coping saw, wherein the tension control mechanism further includes a spring topper disposed on a top surface of the detensioner, and wherein the detensioner is configured to be moved to compress the spring independently of the spring topper.

In some aspects, the techniques described herein relate to a coping saw, wherein the frame includes a first arm and a second arm opposing the first arm to support the saw blade, and wherein an inside portion of the second arm includes at least one indicator configured to indicate a rotational position of the saw blade.

In some aspects, the techniques described herein relate to a powered coping saw, including: a housing; a saw blade; a frame attached to the housing; and an actuator at least partially disposed within the housing, wherein the actuator includes: an electric motor to output rotational motion about a central axis, a drive adapter coupled to the electric motor and configured to rotate about the central axis, a drive pin affixed to a bottom surface of the drive adapter in a position offset from the central axis, a spacer affixed to the drive pin, and an output member slidably disposed within the housing and coupled to the saw blade, the output member defining a space to receive the spacer, wherein rotation of the drive adapter causes the spacer to revolve about the central axis and move the output member to translate the rotational motion of the electric motor into a reciprocating linear motion of the saw blade.

In some aspects, the techniques described herein relate to a powered coping saw, wherein the output member is a Scotch yoke output that translates the rotational motion of the electric motor into the reciprocating linear motion.

In some aspects, the techniques described herein relate to a powered coping saw, wherein: the drive adapter includes a plurality of openings spaced at different angular intervals around the central axis; and the drive pin is configured to be received in different openings of the plurality of openings to adjust a stroke length of the saw blade.

In some aspects, the techniques described herein relate to a powered coping saw, wherein: the output member includes a spool including a center portion, a first end, and a second end, and a circular shape of the spool enables the spool and the saw blade to be rotated within the housing to orient the saw blade at a different angle relative to the frame without detaching the saw blade from the output member.

In some aspects, the techniques described herein relate to a powered coping saw, further including a blade adjustment component having at least one rail, wherein the blade adjustment component is configured to slidably insert into the housing such that the at least one rail engages the spool to lock the saw blade in position during the reciprocating linear motion.

In some aspects, the techniques described herein relate to a powered coping saw, further including: a handle extending to a top portion of the housing; and a variable speed trigger attached to the handle, wherein the variable speed trigger is operably connected to the actuator to control a speed of the reciprocating linear motion based on how far the variable speed trigger is pulled.

The details of one or more implementations are set forth in the accompanying drawings and the description below. Other features will be apparent from the description and drawings, and from the claims.

### BRIEF DESCRIPTION OF THE DRAWINGS

FIG. 1A is an isometric view of an example implementation of a powered coping saw.

FIG. 1B is a side view of the example powered coping saw of FIG. 1A.

FIG. 1C is a bottom isometric view of a top housing for the powered coping saw of FIG. 1A.

FIG. 2 is an exploded view of the example powered coping saw of FIGS. 1A and 1B.

FIG. 3A is a bottom isometric view of a drive adapter for the powered coping saw.

FIG. 3B is a side view of the drive adapter for the powered coping saw.

FIG. 4A is an isometric view of a Scotch yoke output for the powered coping saw.

FIG. 4B is a side view of the Scotch yoke output for the powered coping saw.

FIG. 5A is an isometric, partial, cut away view of a Scotch yoke mechanism, a saw blade, and a blade adjustment component for the powered coping saw in a first position.

FIG. 5B is an isometric, partial, cut away view of the Scotch yoke mechanism, the saw blade, and the blade adjustment component for the powered coping saw in a second position.

FIG. 5C is side, partial, cut away view of the Scotch yoke mechanism, the saw blade, and the blade adjustment component for the powered coping saw in the first position.

FIG. 5D is a side, partial, cut away view of the Scotch yoke mechanism, the saw blade, and the blade adjustment component for the powered coping saw in the second position.

FIG. 6A is an isometric, partial, cut away view of the Scotch yoke mechanism, the saw blade, and the blade adjustment component with the blade adjustment component disengaged from the Scotch yoke mechanism and the saw blade in a first position.

FIG. 6B is an isometric, partial, cut away view of the Scotch yoke mechanism, the saw blade, and the blade adjustment component with the blade adjustment component disengaged from the Scotch yoke mechanism and the saw blade in a second position.

FIG. 6C is an isometric, partial, cut away view of the Scotch yoke mechanism, the saw blade, and the blade adjustment component with the blade adjustment component engaged with the Scotch yoke mechanism and the saw blade in the second position.

FIG. 7A is a side view of a tension control mechanism.

FIG. 7B is a top, isometric view of the tension control mechanism of FIG. 7A with a shroud removed.

FIG. 8A is an isometric view of a detensioner.

FIG. 8B is a bottom view of the detensioner of FIG. 8A.

FIG. 9A is a side view of the tension control mechanism in an operating state.

FIG. 9B is a side view of the tension control mechanism in a first detension state.

FIG. 9C is a bottom view of the tension control mechanism in the first detension state.

FIG. 9D is a bottom view of the tension control mechanism in a second detension state.

FIG. 9E is a bottom view of the tension control mechanism in a third detension state.

FIG. 9F is a bottom view of the tension control mechanism in a fourth detension state.

FIG. 9G is a side view of the tension control mechanism in the fourth detension state.

FIG. 10 is an illustration of an inside portion of a second arm of the frame having an indicator to indicate a position of the saw blade.

### DETAILED DESCRIPTION

This document describes example implementations of a powered coping saw designed to improve the efficiency, accuracy, and precision of coping tasks. The example implementations of the powered coping saw described below are able to make coping cuts faster compared to using a manual, or hand-powered, coping saw.

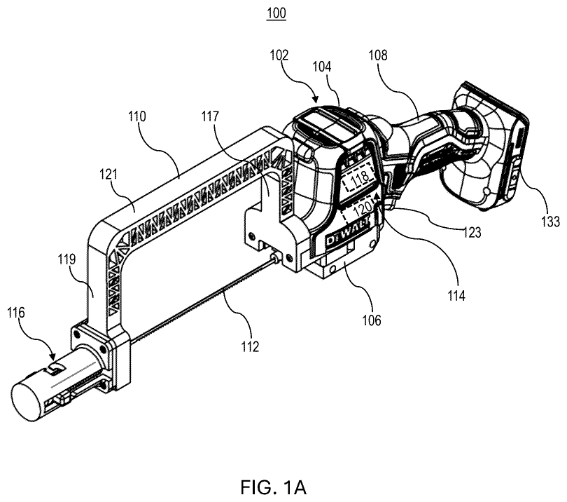

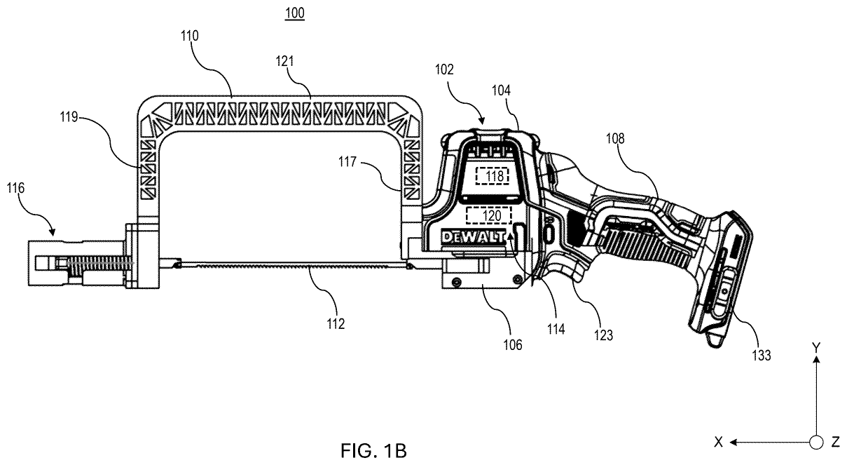

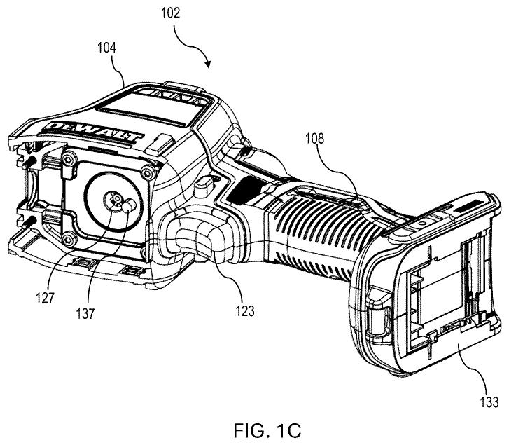

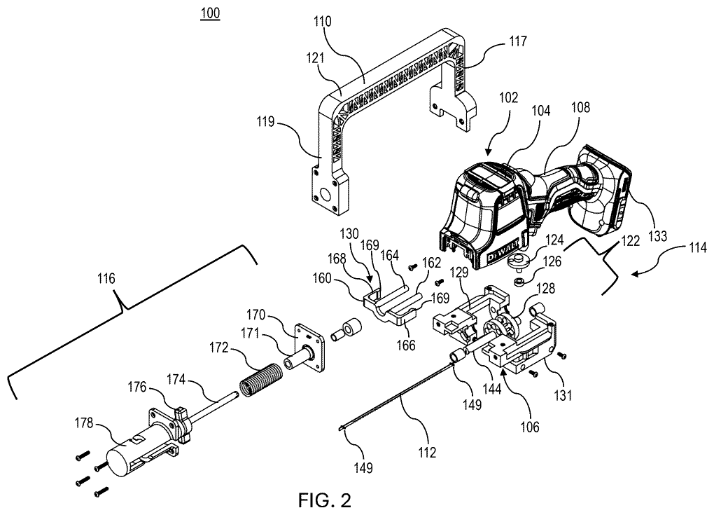

FIG. 1A is an isometric view of an example implementation of a powered coping saw 100, FIG. 1B is a side view of the powered coping saw 100 of FIG. 1A, FIG. 1C is a bottom isometric view of a top housing 104 for the powered coping saw 100 of FIG. 1A, and FIG. 2 is an exploded view of the powered coping saw 100 of FIGS. 1A and 1B. The powered coping saw 100 may include a housing 102 having the top housing 104 and a bottom housing 106, a handle 108, a frame 110 affixed to the housing 102, a saw blade 112, an actuator 114, and a tension control mechanism 116, as well as other components discussed in more detail below.

The housing 102, including the top housing 104 and the bottom housing 106, forms an outer body or shell of the powered coping saw 100. The housing 102 is a casing that protects various internal components that are housed within the casing, including the actuator 114 and its components. The housing 102 may be constructed from any of a variety of materials, including polymers and/or composites, such as fiberglass-reinforced nylon, which are designed to have high strength and durability. The housing 102 may include some metal sections for added durability and heat dissipation.

As illustrated in FIGS. 1A, 1B, and 2, the actuator 114 may be at least partially housed in the housing 102. The actuator 114 may be operable to apply a reciprocating motion to the saw blade 112 while the tension control mechanism 116 maintains tension on the saw blade 112. The actuator 114 may include an electric motor 118 and a reciprocating mechanism 120. The reciprocating mechanism 120 may be coupled to the electric motor 118 and may be configured to convert rotational motion of the electric motor 118 into the reciprocating motion, where the reciprocating motion may be a linear motion. For example, the electric motor 118 may be configured to apply rotational force around a Y-axis, as shown in FIG. 1B. The reciprocating mechanism 120 may be configured to transfer the rotational force around the Y-axis into a linear, reciprocating motion along an X-axis. For example, the reciprocating mechanism 120 may provide reciprocating motion to the saw blade 112, which is coupled at one end to the reciprocating mechanism 120, while the frame 110 remains stationary relative to the saw blade 112 and the housing 102.

In some implementations, the electric motor 118 includes a brushless, direct current (DC) motor. The electric motor 118 may include one or more sensors (e.g., Hall sensors) to enable variable speed control of the electric motor 118. In some implementations, other types of electric motors may be used.

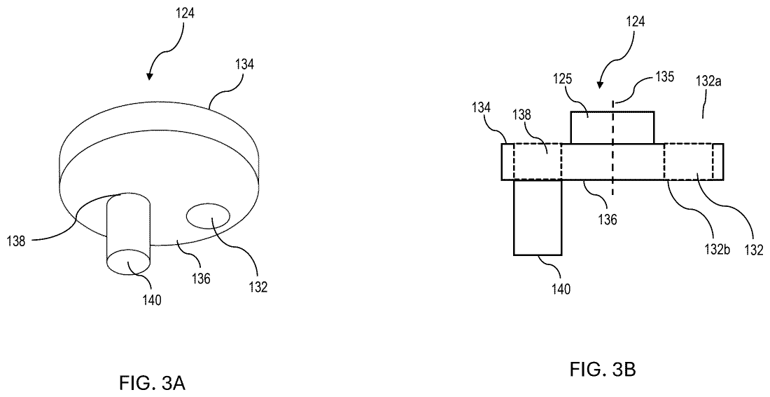

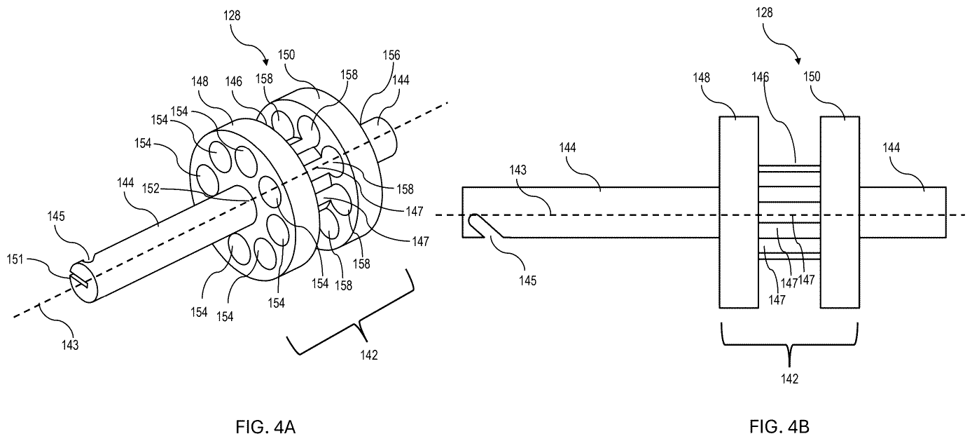

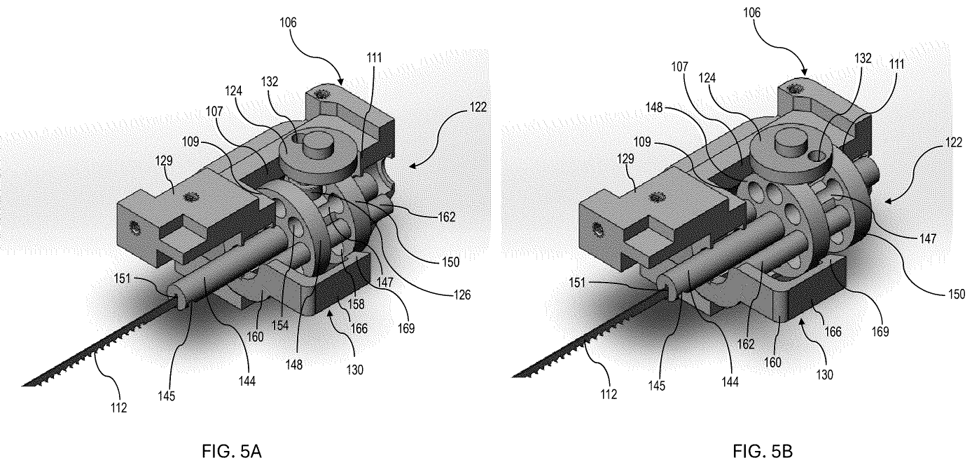

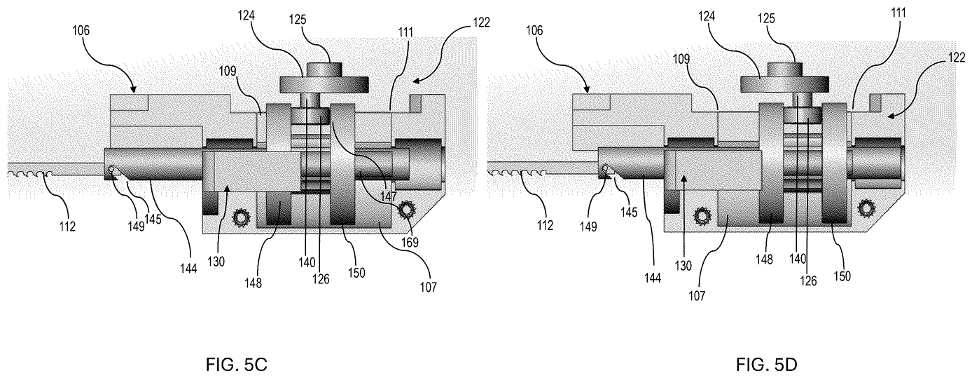

In some implementations, the reciprocating mechanism 120 may include a Scotch yoke mechanism 122. The Scotch yoke mechanism 122 may be driven by the electric motor 118. The Scotch yoke mechanism 122 may include a drive adapter 124, a spacer 126, and a Scotch yoke output 128. The Scotch yoke mechanism 122 may translate the rotational motion of the electric motor 118 into reciprocating motion (or linear motion) through the drive adapter 124 and the spacer 126 that rotates between the Scotch yoke output 128, which slides back and forth within the bottom housing 106. Referring to FIGS. 2-5D, FIG. 3A is a bottom view of the drive adapter 124 for the powered coping saw 100, FIG. 3B is a side view of the drive adapter 124 for the powered coping saw 100, FIG. 4A is an isometric view of the Scotch yoke output 128 for the powered coping saw 100, FIG. 4B is a side view of the Scotch yoke output 128 for the powered coping saw 100, FIG. 5A is an isometric, partial, cut away view of the Scotch yoke mechanism 122, the saw blade 112, and a blade adjustment component 130 (also may be referred to as a blade orientation component or a blade position component) for the powered coping saw 100 in a first position, and FIG. 5B is an isometric, partial, cut away view of the Scotch yoke mechanism 122, the saw blade 112, and the blade adjustment component 130 for the powered coping saw 100 in a second position. FIG. 5C is side, partial, cut away view of the Scotch yoke mechanism 122, the saw blade 112, and the blade adjustment component 130 for the powered coping saw 100 in the first position, and FIG. 5D is a side, partial, cut away view of the Scotch yoke mechanism 122, the saw blade 112, and the blade adjustment component 130 for the powered coping saw 100 in the second position.

The drive adapter 124 may be a cylindrical member (or disc) that includes a top portion 125. The drive adapter 124 may include a cylindrical column 132 therethrough. The top portion 125 may be a cylindrical member (or disc) that may be sized to fit within and/or integrated into an opening 127 that connects to the electric motor 118 and/or a transmission of the electric motor 118, as shown in FIG. 1C. The cylindrical column 132 may have a first opening 132a at a top surface 134 of the drive adapter 124. In some implementations, the cylindrical column 132 may have a second opening 132b at a bottom surface 136 of the drive adapter 124. The cylindrical column 132 may be offset or off-center from a central axis 135 of the drive adapter. For example, the cylindrical column 132 may be sized to receive a pin 137, which may be an output pin of a transmission coupled to the electric motor 118, as shown in FIG. 1C. The pin 137 is affixed to the drive adapter 124 via the cylindrical column 132. The rotation of the electric motor 118 causes the pin 137 to revolve about the motor output shaft/the central axis 135, which causes the drive adapter 124 to rotate about the central axis 135.

In some implementations, the drive adapter 124 is used to adjust a stroke length of the saw blade 112 when the powered coping saw 100 reciprocates. In some implementations, the drive adapter 124 may include multiple different openings spaced at different angular intervals around the central axis 135 to provide various different stroke length options.

The drive adapter 124 may include an opening 138, which may be an off-center opening in the bottom surface 136 of the drive adapter 124. In some implementations, the opening 138 may not go through to the top surface 134 of the drive adapter 124. In some other implementations, the opening 138 may extend from the bottom surface 136 through to the top surface 134. The opening 138 is sized to receive a drive pin 140. The drive pin 140 may be a cylindrical-shaped pin that is affixed (e.g., press fit) into the opening 138 such that it extends from the bottom surface 136 of the drive adapter 124.

As seen in FIG. 2, FIG. 5A, FIG. 5C, and FIG. 5D, the spacer 126 may be affixed to the drive pin 140. The spacer 126 may be a cylindrical disc with an opening in the center to mount to the drive pin 140. The spacer 126 moves with the rotational motion imparted to the drive adapter 124 via the drive pin 140. The spacer 126 revolves about the central axis 135 because the drive pin 140, about which the spacer 126 is positioned, is affixed in the opening 138 in an eccentric/off-center manner and because the cylindrical column 132 that receives the pin 137 is off-center of the drive adapter 124. That is, the drive adapter 124, the drive pin 140, and the spacer 126 revolve about the central axis 135 due to the offset locations of the cylindrical column 132 and the opening 138, with the cylindrical column 132 and the opening 138 being offset (or displaced) relative to a geometric center of the drive adapter 124, namely the central axis 135. The spacer 126 is sized to fit and be disposed in the Scotch yoke output 128, as described in more detail below.

In some example implementations, the drive adapter 124 may not be used and the spacer 126 may be affixed directly to the pin 137. In such implementations, a radial position of the pin 137 relative to the output shaft of the motor 118 may be selected to correspond to a desired stroke length of the saw blade 112.

As seen in FIGS. 2, 4A, 4B, 5A-5D, the Scotch yoke output 128 may include a spool-like member 142 (referred to hereinafter simply as a spool 142) and a pin 144 that may extend along a central axis 143 of the spool 142 and protrude out on either end or both ends of the spool 142. The Scotch yoke output 128 may be disposed in the bottom housing 106, where the bottom housing 106 may include a first portion 129 (e.g., a first half) and a second portion 131 (e.g., a second half) that are fastened or otherwise coupled together. In some other implementations, the bottom housing 106 may be a single integrated unit. The bottom housing 106 may form a cavity 107 (e.g., a space) to receive the Scotch yoke output 128 and to enable the Scotch yoke output 128 to reciprocate back and forth in a linear motion. The cavity 107 may include a front wall 109 and a back wall 111.

The pin 144 may be shaped like a cylindrical tube, which may be a solid tube or a hollow tube. The pin 144 may include a notch 145 and a slot 151 to hold the saw blade 112. As best seen in FIG. 2, FIG. 5C, and FIG. 5D, the saw blade 112 may include a pin 149 on each end of the saw blade 112, where the pin 149 fits into the notch 145 to join (or attach) the saw blade 112 to the Scotch yoke output 128.

The spool 142 may include a center portion 146 (or a core), a first end 148 (or a first flange, disc, or head), and a second end 150 (or a second flange, disc, or head) all of which are centrally positioned about the central axis 143. The center portion 146 may be a central cylindrical drum having an opening (not shown) through which the pin 144 may extend. The center portion 146 may include a set of notches 147 (or grooves) disposed around the center portion 146. The set of notches 147 may be cut into the center portion 146 and may be spaced evenly around the center portion.

The first end 148 and the second end 150 may be flat, circular ends attached to either side of the center portion 146. The first end 148 may include a center opening 152 and a set of openings 154 spaced around the center opening 152. Similarly, the second end 150 may include a center opening 156 and a set of openings 158 spaced around the center opening 156. The center opening 152 and the center opening 156 are sized to receive the pin 144. The set of openings 154 on the first end 148 and the set of openings 158 on the second end 150 may include a same number of openings and also may correspond to a same number of notches from the set of notches 147 on the center portion 146. The set of openings 154 on the first end 148 and the set of openings 158 on the second end 150 may line up and be directly in-line with each other so that the openings have a one-to-one direct line of correspondence and also may have a one-to-one correspondence with the set of notches 147. In this manner, an object may be passed through one opening in the set of openings 154 in the first end 148 along a notch in the set of notches 147, and through a corresponding opening in the set of openings 158 in the second end 150.

In some implementations, for example, the set of openings 154 on the first end 148 and the set of openings 158 on the second end 150 may be spaced evenly around the first end 148 and the second end 150, respectively. For example, the set of openings 154, the set of openings 158, and the set of notches 147 may be spaced at 45 degree intervals around the central axis 143. In this example, the set of openings 154, the set of openings 158, and the set of notches 147 each may include 8 openings or notches, respectively. In some other implementations, the number of openings and notches may be different than 8 and the degree of interval spacing may be different than 45 degrees.

In some implementations, the center portion 146, the first end 148, and the second end 150 may be a single, integrated component. In some implementations, the center portion 146, the first end 148, and the second end 150 may be separate components that are assembled and affixed to the pin 144 to form the spool 142.

The spacer 126 is sized to fit between the first end 148 and the second end 150. The spacer 126 may be affixed to and held in place by the drive pin 140. As the drive adapter 124 rotates, the spacer 126 revolves around the central axis 135 of the drive adapter 124 and translates the rotational motion of the electric motor 118 and the drive adapter 124 into a linear motion by moving the Scotch yoke output 128 to reciprocate back and forth in the bottom housing 106. In other words, the eccentric motion of the drive pin 140 and the spacer 126 translates the rotational motion into linear motion and moves the Scotch yoke output 128, including the spool 142 and the pin 144, back and forth within the cavity 107 of the bottom housing 106 along the central axis 143. Since the saw blade 112 is connected to the pin 144 through the notch 145, the pin 149 and the saw blade 112 reciprocate as well.

As seen in FIG. 5A, the Scotch yoke output 128 is in a first position towards the front wall 109 of the cavity 107. As seen in FIG. 5B, when the drive adapter 124 rotates and drives the spacer 126, the Scotch yoke output 128 is moved to a second position towards the back wall 111 of the cavity 107, as seen in FIG. 5B. As the drive adapter 124 and the spacer 126 continue to rotate, the Scotch yoke output 128 and the attached saw blade 112 continue to reciprocate in the cavity 107.

The blade adjustment component 130 maintains the position of the pin 144 and the connected saw blade 112 when the Scotch yoke output 128 is stationary and when the Scotch yoke output 128 is reciprocating. That is, the blade adjustment component 130 locks the pin 144 and the saw blade 112 in position so that the saw blade 112 maintains its position while reciprocating and performing coping tasks on a workpiece. The blade adjustment component 130 may include a body portion 160, a first rail 162, and a second rail 164, where the first rail 162 and the second rail 164 are connected to the body portion 160 and project out from the body portion 160. The first rail 162 and the second rail 164 lock the pin 144 and the saw blade 112 in position by engaging with and interlocking through the set of openings 154 of the first end 148 and the set of openings 158 of the second end 150 along the set of notches 147. This prevents the spool 142, the pin 144, and the saw blade 112 from rotating or rotational motion during reciprocating operation. The blade adjustment component 130 may include at least two rails (e.g., the first rail 162 and the second rail 164) to interlock with at least two of the set of openings 158.

The body portion 160 may include a first arm 166 and a second arm 168 that project out from the body portion 160 in a same direction as the first rail 162 and the second rail 164. The first arm 166 and the second arm 168 may include a hook portion 169 at the end of each arm. The first arm 166, the second arm 168, and the hook portion 169 at the end of each arm may slidingly engage with the bottom housing 106 and lock into place. In this manner, the blade adjustment component 130 is fixed in position to the bottom housing 106 during operation of the powered coping saw 100.

As described above, the blade adjustment component 130 locks the saw blade 112 in position during operation. As shown in FIGS. 2, 5A, and 5B, the teeth of the saw blade 112 may be oriented in a same direction as the frame 110. For certain coping tasks, it may be desirable to change the angle of the saw blade 112 with respect to the frame 110.

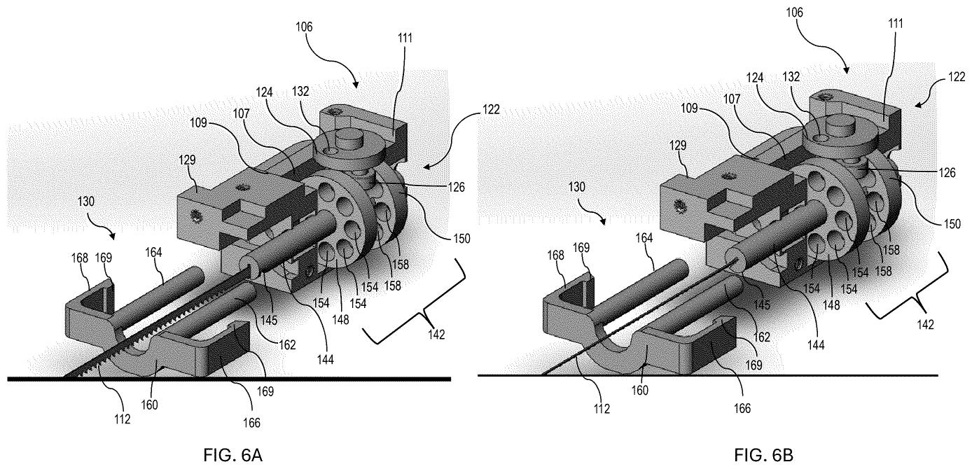

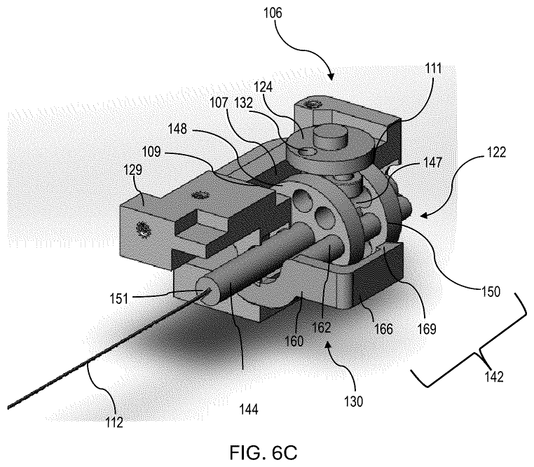

FIGS. 6A-6C illustrate the operation of the powered coping saw 100 to rotate the saw blade 112 to a different angle to perform coping tasks with the saw blade 112 fixed at a different angle. FIG. 6A is an isometric, partial, cut away view of the Scotch yoke mechanism 122, the saw blade 112, and the blade adjustment component 130 with the blade adjustment component 130 disengaged from the Scotch yoke mechanism 122 and the saw blade 112 in a first position. On the blade adjustment component 130, the first arm 166 and the second arm 168 of the body portion 160 may be flexible and may be squeezed towards each other to disengage the hook portion 169 so that the blade adjustment component 130 may be removed from the bottom housing 106. That is, the blade adjustment component 130 may release and slidably disengage from the bottom housing 106. In this manner, the first rail 162 and the second rail 164 disengage from the set of openings 154, the set of notches 147, and the set of openings 158.

Once the blade adjustment component 130 is removed from the bottom housing 106, the Scotch yoke output 128 may be rotated to change the angle of the saw blade 112. FIG. 6B is an isometric, partial, cut away view of the Scotch yoke mechanism 122, the saw blade 112, and the blade adjustment component 130 with the blade adjustment component 130 disengaged from the Scotch yoke mechanism 122 and the saw blade 112 in a second position. More specifically, the spool 142 and the pin 144 to which the saw blade 112 is connected may be rotated within the cavity 107 of the bottom housing 106. The circular shape of the spool 142 enables the rotation of the spool 142, the pin 144, and the attached saw blade 112 without having to detach the saw blade 112 from the pin 144. The spool 142 may be rotated to any desired position that aligns the first rail 162 and the second rail 164 with the set of openings 154, the set of notches 147, and the set of openings 158. For example, when the set of openings 154, the set of notches 147, and the set of openings 158 are spaced 45 degrees apart, the spool 142 may be rotated and locked in place in 45 degree increments.

Once the spool 142 and the saw blade 112 are rotated to a desired angle, the blade adjustment component 130 is inserted into the bottom housing 106 so that the first rail 162 and the second rail 164 engage with the set of openings 154, the set of notches 147, and the set of openings 158. FIG. 6C is an isometric, partial, cut away view of the Scotch yoke mechanism 122, the saw blade 112, and the blade adjustment component 130 with the blade adjustment component 130 engaged with the Scotch yoke mechanism 122 and the saw blade 112 in the second position. After the blade adjustment component 130 has been engaged and inserted into the bottom housing 106, the powered coping saw 100 may be used for coping tasks with the saw blade 112 in the second position.

During operation, as discussed above, one end of the saw blade 112 is connected to the pin 144 of the Scotch yoke output 128. The other end of the saw blade 112 is connected to the tension control mechanism 116. The tension control mechanism 116 maintains tension on the saw blade 112 while the powered coping saw 100 is at rest and during operation. The tension control mechanism 116 also provides a mechanism to release the tension of the saw blade 112 so that the saw blade 112 may be rotated, as described above, or may be changed out for a different blade. FIGS. 1B and 2 illustrate the connection of the saw blade 112 to the tension control mechanism 116 and illustrate the components of the tension control mechanism 116.

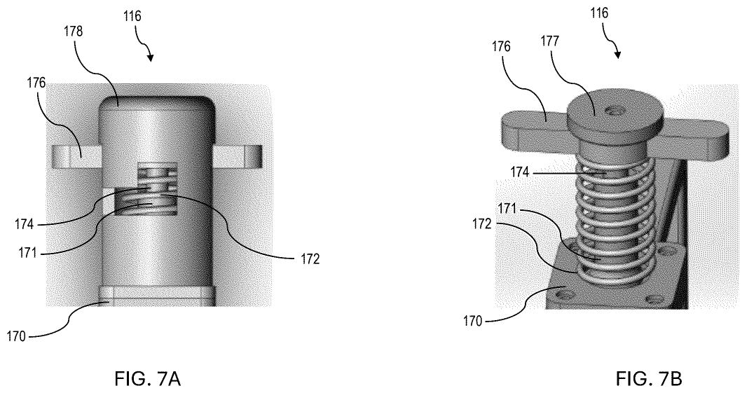

The tension control mechanism 116 may be affixed to the frame 110. The tension control mechanism 116 may include an end cap 170, a spring 172, a pin 174, a detensioner 176, and a shroud 178 (e.g., a cover). Referring also to FIGS. 7A and 7B, FIG. 7A is a side view of the tension control mechanism 116 and FIG. 7B is a top, isometric view of the tension control mechanism 116 with the shroud 178 removed. The end cap 170 is affixed to the frame 110. The end cap 170 may include a stem 171 that is a hollow tube. The spring 172 may fit over the stem 171 and the pin 174 may be received in an opening/hole of the stem 171. The pin 174 goes through the frame 110 and provides a connection point for the saw blade, similar to the pin 144. The other end of the pin 174 is connected to a spring topper 177 that is disposed on a top surface of the detensioner 176. The spring topper 177 may not be connected to the detensioner 176, and the detensioner 176 may be moved independently of the spring topper 177.

The spring 172 is held in compression against the end cap 170 and the frame 110, which is stationary (or grounded). That is, the frame 110 does not move with the reciprocating motion of the saw blade 112. The spring 172 under compression reduces the variation in tension of the saw blade 112 between each end of the stroke during reciprocating motion. In some implementations, the spring 172 may be a long spring with a low spring constant to reduce the variation in tension of the saw blade 112 during reciprocating motion. In some other implementations, a different type of spring may be used.

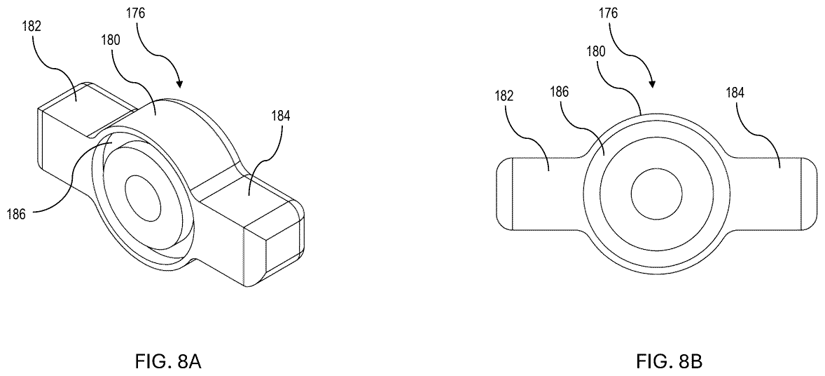

The shroud 178 may at least partially enclose the spring 172. Within the shroud 178, the spring 172 is connected to (or in contact with) the detensioner 176. The detensioner 176 is used to compress the spring 172 to relieve the tension on the pin 174 and the saw blade 112 so that the saw blade 112 may be changed. FIG. 8A is an isometric view of the detensioner 176 and FIG. 8B is a bottom view of the detensioner 176. The detensioner 176 may have a wingnut like shape and include a body portion 180, a first arm 182, and a second arm 184. The body portion 180 may be a rounded or circular center portion of the detensioner 176. The body portion 180 may include a hollow section 186. The hollow section 186 follows the rounded or circular shape of the body portion 180, and the hollow section 186 may be shaped and sized to receive a top portion of the spring 172. That is, a diameter of the hollow section 186 may be sized such that a diameter of the top part of the spring 172 fits within the hollow section 186. The top part of the spring 172 engages an interior surface of the hollow section 186 to enable the detensioner 176 to compress the spring 172.

The first arm 182 and the second arm 184 may be square or rectangular in shape and may extend outward from the body portion 180. The first arm 182 and the second arm 184 provide a surface or gripping area for a user to press or grip or engage to move the detensioner 176 to compress the spring 172. The first arm 182 and the second arm 184 also provide a surface or gripping area for the detensioner 176 to be rotated. When the detensioner 176 is rotated, the pin 174 may not be rotated and may stay in its original position. The detensioner 176 may be moved and rotated within the shroud 178.

The shroud 178 may be a solid, cylindrical cover having one or more openings to enable the movement and rotation of the detensioner 176 within the shroud 178. For example, the shroud 178 includes openings that are opposite each other to enable the first arm 182 and the second arm 184 to extend outside of the shroud 178 to provide a gripping or maneuvering point for a user to engage the detensioner 176.

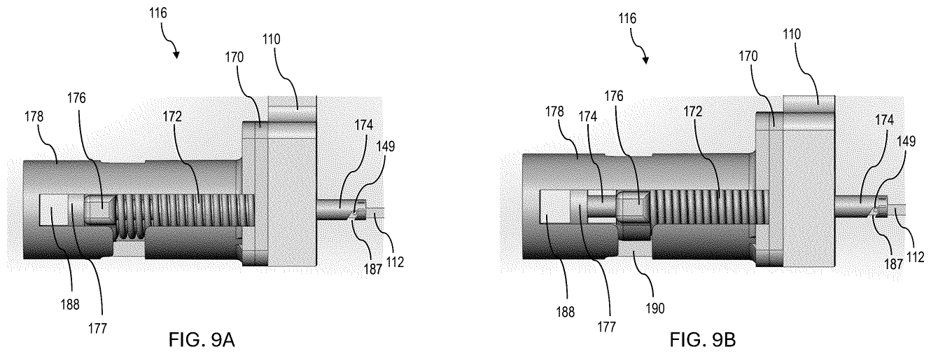

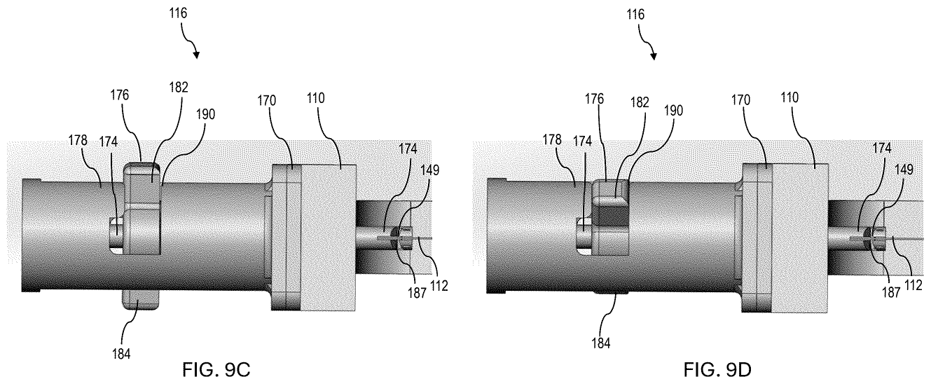

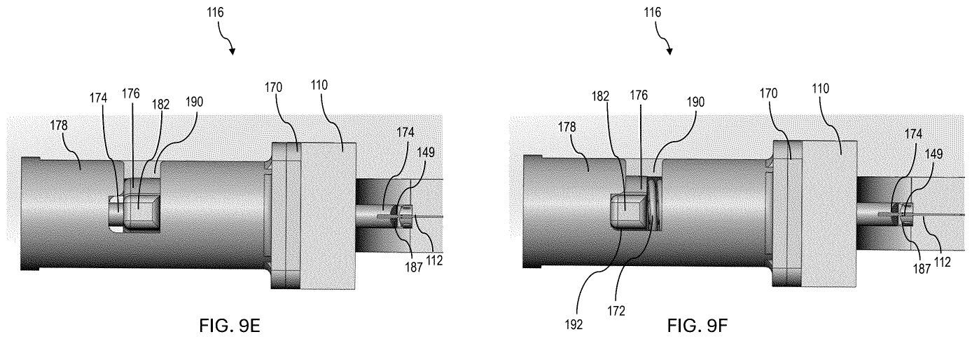

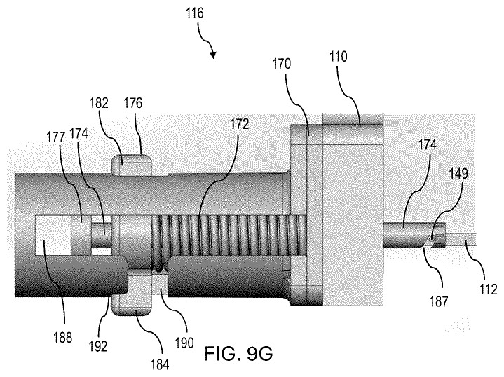

FIGS. 9A-9G illustrate the operation of the tension control mechanism 116 to relieve the tension on the saw blade 112. There may be multiple states or positions that the detensioner 176 may be moved into relative to the shroud 178 as illustrated. At one or more of these various states or positions, the tension on the saw blade 112 may be reduced (or relieved) enough to enable the saw blade 112 to be disengaged from the pin 174 and to be removed, and a new saw blade to be inserted into the pin 174. Additionally, when the tension on the saw blade 112 is reduced, the pin 174 may be rotated to rotate the saw blade 112 to match a rotation of the saw blade 112 on the blade adjustment component 130. The spring topper 177 may be rotated to rotate the pin 174, or the pin 174 and the saw blade 112 may be rotated by grabbing and rotating the pin 149.

FIG. 9A is a side view of the tension control mechanism 116 in an operating state. In FIG. 9A, the tension control mechanism 116 is illustrated in a state when the powered coping saw 100 may be in operation. The spring 172 maintains the tension on the saw blade 112. As illustrated, the saw blade 112 is coupled to the pin 174 using pins 149 on the saw blade 112 to engage a notch 187 on the pin 174. FIG. 9B is a side view of the tension control mechanism 116 in a first detension state, where a detension state refers to the changing position of the detensioner 176. In FIG. 9B, the detensioner 176 is moved within the shroud 178 towards the end cap 170 and compresses the spring 172 in a first compression state. The detensioner 176 moves away from the spring topper 177, which remains stationary within the shroud 178, such that the pin 174 is visible within the shroud 178. Openings 188 on either side of the shroud 178 allow the first arm 182 and the second arm 184 to be gripped so that the detensioner 176 can be moved into the first detension state. In this state, the first arm 182 and the second arm 184 are aligned with openings 190 in the shroud 178, where the openings 190 are between a section of the shroud 178 with a space sized to receive the first arm 182 and the second arm 184. FIG. 9C is a bottom view of the tension control mechanism 116 in the first detension state, which is the same state as FIG. 9B, but just showing a different view. In FIG. 9C, the first arm 182 and the second arm 184 are seen protruding through the shroud 178.

FIG. 9D is a bottom view of the tension control mechanism 116 in a second detension state and the spring 172 in the first compression state. In FIG. 9D, the detensioner 176 is rotated to a position into the openings 190. In this second detension state, the tension on the saw blade 112 is relieved and at least partially locked in place to enable the saw blade 112 to be removed from the pin 174 by pulling on the pin 174. The tension is relieved enough to enable pulling on the pin 174. The first arm 182 and the second arm 184 are rotated at least partially into the openings 190. FIG. 9E is a bottom view of the tension control mechanism 116 in a third detension state with the spring 172 in the first compression state. In this state, the detensioner 176 is rotated further into the openings 190.

FIG. 9F is a bottom view of the tension control mechanism 116 in a fourth detension state and FIG. 9G is a side view of the tension control mechanism 116 in the fourth detension state with the spring 172 in a second compression state. In this state, the detensioner 176 is released into the openings 192, where the detensioner 176 is locked in a position within the shroud 178. In this state, the tension on the saw blade 112 is relieved to enable the saw blade 112 to be removed from the pin 174 by pulling on the pin 174.

Referring back to FIGS. 1A, 1B, and 2, the frame 110 may be configured to support the saw blade 112 between a first arm 117 and the second arm 119. The frame 110 also may include a third arm 121 connecting the first arm 117 and the second arm 119. For example, the frame 110 may be U-shaped, C-shaped, or otherwise shaped to enable the first arm 117 and the second arm 119, which are opposing each other, to support the saw blade 112 in between. In some examples, the first arm 117 and the second arm 119 may be substantially parallel to one another. In some implementations, while the frame 110 may provide stability for the saw blade 112, the frame 110 may not provide the tension for the saw blade 112 like a conventional coping saw. The frame 110 also provides space for the powered coping saw 100 to make deep cuts on a workpiece.

The frame 110 may be constructed from any of a variety of durable materials, such as high-strength steel, aluminum, or reinforced polymers, to ensure rigidity, elasticity, and/or longevity while maintaining a lightweight design.

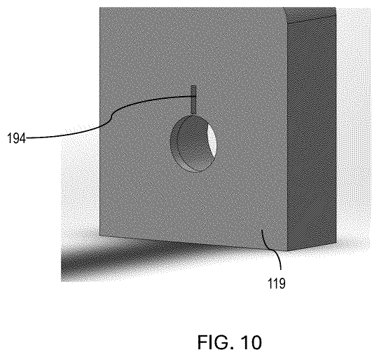

FIG. 10 is an illustration of an inside portion of the second arm 119 having an indicator 194 to indicate a position of the saw blade 112. In this example, a single indicator is used. In other examples, multiple indicators may be used to indicate a position of the saw blade 112 as it is rotated.

In some instances, the saw blade 112 may include a forward biased tooth configuration. For example, a forward biased tooth configuration may include a configuration where the teeth of the saw blade 112 are angled toward an end of the powered coping saw 100 opposite the handle 108. In some instances, the saw blade 112 may include a backwards biased tooth configuration. For example, a backwards biased tooth configuration may include a configuration where the teeth of the saw blade 112 are angled away from the end of the powered coping saw 100 opposite the handle 108. In some instances, the saw blade 112 may include a neutrally biased tooth configuration where the teeth of the saw blade 112 are straight (e.g., substantially perpendicular to the axis along which the saw blade 112 reciprocates), rather than angled toward or away from the end of the powered coping saw 100. In some example implementations, the saw blade 112 may include a combination of forward biased teeth, backward biased teeth, and/or neutrally biased teeth. The different teeth configurations of the saw blade 112 provide versatility to the powered coping saw 100, enabling the powered coping saw 100 to be used in a variety of situations and for a variety of different cutting styles.

In this example implementation, the handle 108 may be formed from the housing 102 and, more specifically, the top housing 104. In this example implementation, the handle 108 may extend to the top housing 104 that houses at least a portion of the actuator 114 and its components. It is understood that the housing 102 may take different shapes and forms to support a weight-balanced and ergonomically user-friendly powered coping saw 100, and that this is merely one example.

In some example implementations, the handle 108 may form a portion of the housing 102. The handle 108 provides an ergonomic grip area for a user to grip the powered coping saw 100. The handle 108 enables the user to wrap their fingers around the handle 108 when using the powered coping saw 100. The handle 108 may be constructed from any of the same materials as the housing 102, including polymers and/or composites, such as fiberglass-reinforced nylon. In some instances, the handle 108 may be at least partially hollow and/or include space for components such as electronic control modules, electrical wiring, other modules, and the like.

In some implementations, the powered coping saw 100 may include a variable speed trigger 123 attached to the handle 108 and operably connected to the actuator 114 for turning the electric motor 118 on and off and for controlling a speed of the reciprocating motion of the saw blade 112, as seen best in FIG. 1B. The variable speed trigger 123 is a type of switch that allows the user to control the operating speed of the powered coping saw 100 by varying how far the variable speed trigger 123 is pulled. For example, pulling the variable speed trigger 123 just slightly results in the saw blade 112 reciprocating at a low speed. Pulling the variable speed trigger 123 further increases the speed proportionally. Pulling the variable speed trigger 123 all the way results in the saw blade 112 reciprocating at its maximum speed. That is, the variable speed trigger 123 may control a speed of the reciprocating linear motion based on how far the variable speed trigger 123 is pulled. A release of the variable speed trigger 123 stops the saw blade 112 from reciprocating. In some instances, other types of control mechanisms, such as a rotary dial, push-button controls, on/off switches, and/or selectable speed controls, may be used to activate and/or control the speed of the actuator 114.

In some implementations, the powered coping saw 100 may include a battery receptacle 133 that is configured to receive a battery pack (not shown) to power the electric motor 118. The battery receptacle 133 may be located at one end of the handle 108. The battery receptacle 133 may be configured to receive a slide-type battery pack and/or may be configured to receive a tower-type battery pack. In some implementations, the battery pack may include a removable, rechargeable battery pack. The example battery pack may have a nominal voltage of 12V, 18V, 20V, and/or 24V, which may offer varying degrees of power and runtime.

In some implementations, rather than an externally attached battery pack, the handle 108 may be hollow and may include a cavity and connections for an internal integrated battery pack or batteries to be inserted within the handle 108. Additionally, or alternatively, the powered coping saw 100 may be corded to provide a constant source of power.

The terminology used herein is for the purpose of describing particular example implementations only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected, or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers, and/or sections, these elements, components, regions, layers, and/or sections should not be limited by these terms. These terms may be only used to distinguish one element, component, region, layer, or section from another region, layer, or section. Terms such as “first,” “second,” and other numerical terms when used herein do not imply a sequence or order unless clearly indicated by the context. Thus, a first element, component, region, layer, or section discussed below could be termed a second element, component, region, layer, or section without departing from the teachings of the example implementations.

Terms of degree such as “generally,” “substantially,” “approximately,” and “about” may be used herein when describing the relative positions, sizes, dimensions, or values of various elements, components, regions, layers, and/or sections. These terms mean that such relative positions, sizes, dimensions, or values are within the defined range or comparison (e.g., equal or close to equal) with sufficient precision as would be understood by one of ordinary skill in the art in the context of the various elements, components, regions, layers, and/or sections being described.

While certain features of the described implementations have been illustrated as described herein, many modifications, substitutions, changes, and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components, and/or features of the different implementations described.

What is claimed is:

1. A coping saw comprising:
a housing having a handle;
a saw blade;
a frame attached to the housing; and
an actuator at least partially disposed within the housing, wherein the actuator includes:
an electric motor,
a Scotch yoke mechanism driven by the electric motor and having a plurality of openings, the Scotch yoke mechanism to translate rotational motion of the electric motor to reciprocating motion of the saw blade, and
a blade adjustment component to lock the saw blade in position using the plurality of openings.

2. The coping saw of claim 1, wherein:
the blade adjustment component is slidably removable from the housing; and
the Scotch yoke mechanism is rotatable to rotate the saw blade and to lock the saw blade in a different position.

3. The coping saw of claim 1, wherein:
the Scotch yoke mechanism includes a spool having a first end having the plurality of openings and a second end having the plurality of openings.

4. The coping saw of claim 3, wherein:
the blade adjustment component includes at least one rail to interlock with one of the plurality of openings on the first end and the second end to lock the saw blade in position.

5. The coping saw of claim 4, wherein:
the blade adjustment component includes at least two rails to interlock with at least two of the plurality of openings on the first end and the second end to lock the saw blade in position.

6. The coping saw of claim 1, further comprising:
a tension control mechanism having a spring to maintain tension on the saw blade as the saw blade reciprocates.

7. The coping saw of claim 6, wherein the tension control mechanism includes:
a shroud at least partially enclosing the spring; and
a detensioner that is disposed within the shroud and configured to move within the shroud to compress the spring and to relieve tension on the saw blade.

8. A coping saw comprising:
a housing having a handle;
a saw blade;
a frame attached to the housing;
an actuator at least partially disposed within the housing, the actuator to impart linear motion to the saw blade; and
a tension control mechanism having a spring to maintain tension on the saw blade as the saw blade reciprocates, wherein the tension control mechanism includes:
a shroud at least partially enclosing the spring; and
a detensioner that is disposed within the shroud and configured to move within the shroud to compress the spring and to relieve tension on the saw blade.

9. The coping saw of claim 8, wherein the actuator comprises:
an electric motor,
a Scotch yoke mechanism driven by the electric motor and having a plurality of openings, the Scotch yoke mechanism to translate rotational motion of the electric motor to reciprocating motion of the saw blade, and
a blade adjustment component to lock the saw blade in position using the plurality of openings.

10. The coping saw of claim 8, wherein the shroud includes at least one opening, and wherein the detensioner includes at least one arm configured to extend outside of the shroud through the at least one opening to provide a gripping area for a user to move the detensioner.

11. The coping saw of claim 10, wherein the detensioner is rotatable within the shroud to engage the at least one arm with a portion of the shroud and lock the detensioner in a detension state that relieves the tension on the saw blade.

12. The coping saw of claim 8, wherein the detensioner includes a body portion having a hollow section, wherein the hollow section is sized to receive a top portion of the spring such that the top portion of the spring engages an interior surface of the hollow section.

13. The coping saw of claim 8, wherein the tension control mechanism further includes a spring topper disposed on a top surface of the detensioner, and wherein the detensioner is configured to be moved to compress the spring independently of the spring topper.

14. The coping saw of claim 8, wherein the frame comprises a first arm and a second arm opposing the first arm to support the saw blade, and wherein an inside portion of the second arm includes at least one indicator configured to indicate a rotational position of the saw blade.

15. A powered coping saw, comprising:
a housing;
a saw blade;
a frame attached to the housing; and
an actuator at least partially disposed within the housing, wherein the actuator comprises:
an electric motor to output rotational motion about a central axis,
a drive adapter coupled to the electric motor and configured to rotate about the central axis,
a drive pin affixed to a bottom surface of the drive adapter in a position offset from the central axis,
a spacer affixed to the drive pin, and
an output member slidably disposed within the housing and coupled to the saw blade, the output member defining a space to receive the spacer, wherein rotation of the drive adapter causes the spacer to revolve about the central axis and move the output member to translate the rotational motion of the electric motor into a reciprocating linear motion of the saw blade.

16. The powered coping saw of claim 15, wherein the output member is a Scotch yoke output that translates the rotational motion of the electric motor into the reciprocating linear motion.

17. The powered coping saw of claim 15, wherein:
the drive adapter includes a plurality of openings spaced at different angular intervals around the central axis; and
the drive pin is configured to be received in different openings of the plurality of openings to adjust a stroke length of the saw blade.

18. The powered coping saw of claim 15, wherein:
the output member comprises a spool including a center portion, a first end, and a second end, and
a circular shape of the spool enables the spool and the saw blade to be rotated within the housing to orient the saw blade at a different angle relative to the frame without detaching the saw blade from the output member.

19. The powered coping saw of claim 18, further comprising a blade adjustment component having at least one rail, wherein the blade adjustment component is configured to slidably insert into the housing such that the at least one rail engages the spool to lock the saw blade in position during the reciprocating linear motion.

20. The powered coping saw of claim 15, further comprising:
a handle extending to a top portion of the housing; and
a variable speed trigger attached to the handle, wherein the variable speed trigger is operably connected to the actuator to control a speed of the reciprocating linear motion based on how far the variable speed trigger is pulled.
